(19) United States
(12) Patent Application Publication
(10) Pub. No.: US 2009/0244601 A1
(43) Pub. Date: Oct. 1, 2009

(54) Systems and Methods for Color Data Compression

(75) Inventor: Peter Johnston, San Francisco, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/324,560

(22) Filed: Nov. 26, 2008

Related U.S. Application Data
(63) Continuation-in-part of application No. 12/078,415, filed on Mar. 31, 2008.
Application No. 12/078,415 is a continuation-in-part of application No. 12/078,417, filed on Mar. 31, 2008.
Application No. 12/078,417 is a continuation-in-part of application No. 12/165,596, filed on Jun. 30, 2008.

(51) Int. Cl. G06F 3/12

(52) U.S. Cl. 358/1.15

(57) ABSTRACT

Systems and methods are provided for transferring image data to a printing device over a network connection. The image data comprises at least one image block associated with a first print page, wherein the image block comprises a plurality of color blocks, each color block being associated with a distinct color plane. In some embodiments, a transition delay may be computed for the transfer of a second print page immediately succeeding the first page. The transition delay is computed based on a function of a physical offset between successive color planes in relation to an order in which the color planes are processed on the printing device and the volume of data in the image block. Further, scheduled transfers of image data associated with the second print page may be delayed by the computed transition delay.

### CROSS REFERENCES TO RELATED APPLICATIONS

This application is a continuation-in-part of commonly-assigned, co-pending applications, U.S. patent application Ser. No. 12/078,415 (inventor: Peter Johnston) filed Mar. 31, 2008, entitled “Systems and Methods for Resolution Switching” (Attorney Docket No. 9546.0054-00); U.S. patent application Ser. No. 12/078,417 (inventors: Isao Hayami and Peter Johnston) filed Mar. 31, 2008, entitled “Systems and Methods for Color Data Compression” (Attorney Docket No. 9546.0066-00); and U.S. patent application Ser. No. 12/165,596 (inventor: Peter Johnston) filed Jun. 30, 2008, entitled “Systems and Methods for Color Data Compression” (Attorney Docket No. 9546.0070-00). The above-mentioned applications are hereby incorporated by reference into this application in their entirety for all purposes.

### TECHNICAL FIELD

This disclosure relates to data compression for printing systems and in particular, to systems and methods for color data compression on laser printers.

### DESCRIPTION OF RELATED ART

A typical printing system may include a print engine that controls various mechanical and electrical parts configured to print data on a page at a predetermined print speed. The print engine is usually controlled by a print controller, which communicates with a print data input device (e.g., a personal computer) and the print engine, to coordinate timing and other parameters related to the printing process. The print controller may receive image data for printing from the input device at an appropriate rate via a data transferring interface, can generate rasterized images, and send them to the print engine for printing.

Some printing systems, such as laser printing systems, may have hard real-time requirements so that once a print job has been initiated, data transfers to the print engine may occur at some set speed without interruption. For instance, in a laser printing system, which is one of a class of page printers, data for each page can be transferred to the print engine at an appropriate speed without interruption. However, the bandwidth of the data transferring interface sometimes may not be sufficient to sustain the print speed. For instance, a page containing high resolution images may have a large data size even after image compression. When such a page is being transferred to the print controller from a printer at the print speed, the image data may exceed the bandwidth for some time period. As a result, the page for printing may not be completely transmitted to the print controller and print engine before the start of physical printing, resulting in a data under-run. Consequently, the page may not be printed properly. The performance of the printing system may therefore be significantly compromised.

Conventional printer controllers may include a page buffer capable of buffering an entire page before printing commences. This may allow for some flexibility in how the print data is transferred to the print controller from the printer. For example, in order to store a full page of print data including high resolution images, the print controller may use a large amount of additional memory for both code and data storage. This may add substantial cost to the printing system. In addition, memory cannot typically be added by users to many existing printers, so an approach using additional memory will not help printers already on the market. Therefore, there is a need for systems and methods that provide a reliable printing solution that can be implemented for existing printers, and that reduces memory requirements in the print engine.

### SUMMARY

Systems and methods are provided for transferring image data to a printing device over a network connection. The image data comprises at least one image block associated with a first print page, wherein the image block comprises a plurality of color blocks, each color block being associated with a distinct color plane. In some embodiments, a transition delay may be computed for the transfer of a second print page immediately succeeding the first page. The transition delay is computed based on a function of a physical offset between successive color planes in relation to an order in which the color planes are processed on the printing device and the volume of data in the image block. Further, scheduled transfers of image data associated with the second print page may be delayed by the computed transition delay.

Embodiments disclosed also relate to software, firmware, and program instructions created, stored, accessed, or modified by processors using computer-readable media or computer-readable memory. The methods described may also be performed on a computer and/or a printing device.

Additional objects and advantages will be set forth in part in the description, which follows, and in part will be obvious from the description, or may be learned by practice. The objects and advantages will be realized and attained by means of the elements and combinations particularly pointed out in the appended claims. It is to be understood that both the foregoing general description and the following detailed description are exemplary and explanatory only and are not restrictive. These and other embodiments are further explained below with respect to the following figures.

### BRIEF DESCRIPTION OF THE DRAWINGS

FIG. 1 shows a block diagram of an exemplary printer.

FIG. 2a is an illustration of two consecutive print pages transferred from an exemplary computer to an exemplary printer, with no transition delay between two consecutive print pages.

FIG. 2b is an illustration of two consecutive print pages transferred from an exemplary computer to an exemplary printer, with a transition delay between two consecutive print pages.

FIG. 3 shows a block diagram indicating an exemplary data flow between an exemplary computer and an exemplary printer for color data compression.

FIG. 4 shows a flow chart of an exemplary color data compression operation process.

### DETAILED DESCRIPTION

Reference will now be made in detail to various embodiments, which are illustrated in the accompanying drawings. Wherever possible, the same reference numbers will be used throughout the drawings to refer to the same or like parts.

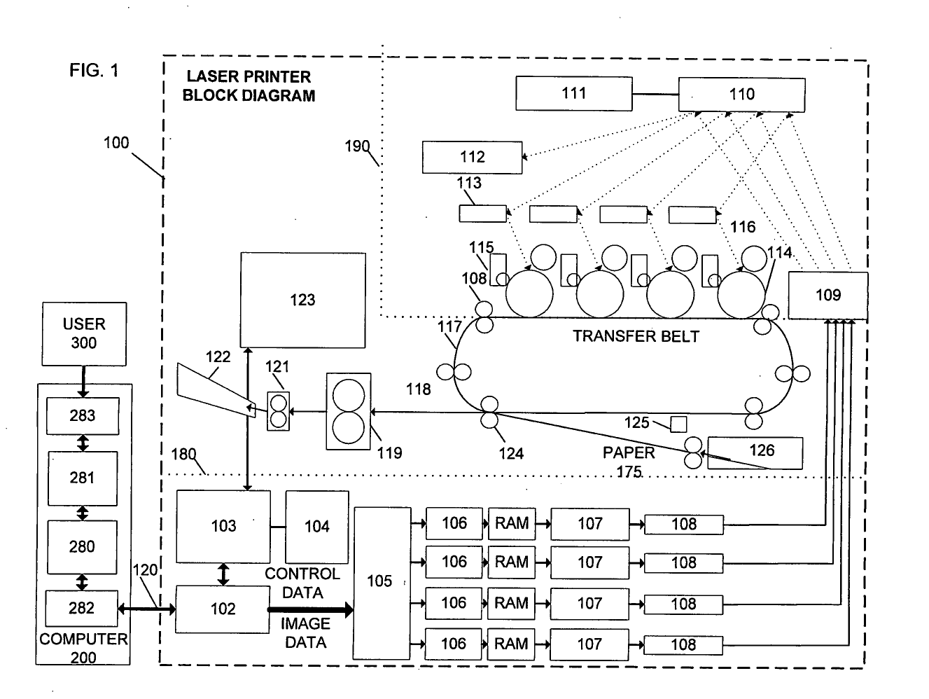

FIG. 1 is a block diagram of exemplary printer 100, which is coupled to exemplary computer 200. In some embodiments, printer 100 may be a laser printer, an LED printer, or any other printer consistent with principles of the present invention. Connection 120 couples computer 200 and printer 100 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB, FIREWIRE and/or serial or parallel ports for transmission of data through appropriate connection 120. The communication links could be wireless links or wired links or any combination consistent with embodiments of the present invention that allows communication between computing device 200, and printer 100.

In some embodiments, connection 120 may operate at a predetermined data transferring frequency, or may otherwise have limited bandwidth. For example, connection 120 may operate at a frequency of 480 MHz and the corresponding maximum raw bandwidth may be 60 M bytes per second. In some embodiments, the maximum transfer rate of raw data may be lower than the maximum raw bandwidth due to encoding and protocol overhead. Under some exemplary protocols, an isochronous mode of transfer may be supported so that a certain amount of bandwidth may be reserved and data delivery at a corresponding transfer rate may be guaranteed. For example, a certain amount of bandwidth may be reserved for each C/M/Y/K image component, and data delivery at the corresponding transfer rate may be guaranteed. The guaranteed transfer rate may be designed to support the rate at which the print engine consumes image data, and/or the print speed of printer 100, to ensure that data under-runs do not occur on printer 100.

In some embodiments, when a multi-component image such as a color image is printed, image data of the multiple color planes may share the available bandwidth of connection 120. For example, for CMYK color printers, which use cyan (“C”), magenta (“M”), yellow (“Y”), and black (“K”) toning materials or developing agents, the print color data may have four planes and may be transferred during the same time frame via connection 120.

In some embodiments, connection 120 may be divided into a plurality of sub-channels. A sub-channel may be a portion of the available bandwidth on connection 120 and may be dedicated to transfer image data associated with a color plane. Some amount of bandwidth may be reserved for each channel, and data delivery at the corresponding transfer rate may be available to each channel. Data may be transferred via the plurality of sub-channels in a parallel manner. In some embodiments, the same bandwidth may be reserved for each sub-channel. In some embodiments, different bandwidths may be reserved for different sub-channels.

In one exemplary embodiment, USB interface 102 may be used as an interface to receive data via a serial pipe. It is contemplated that other interfaces may be used to receive data via other types of connection 120, such as, for example, FIREWIRE or wireless. Data received by USB interface 102 may be routed internally along internal data paths or data and control signal paths, such as a data bus, to various internal functional modules of printer 100 as determined by control logic in printer 100. In some embodiments, data transmitted to printer 100 by computer 200 may also include destination addresses and/or commands to facilitate routing.

In some embodiments, CPU 103, memory 104, control block 105, decompressor module 106 with attached RAM, PWM logic module 107, and driver circuit 108 may be coupled using the data bus. Data received by USB interface 102 may be placed in memory 104 under the control of the CPU 103, according to some embodiments of the present invention. Decompressor 106 and attached RAM may also be coupled to PWM logic module 107. In some embodiments, decompressor module 106 may receive compressed image data, decompress the received image data, store the decompressed data in RAM, and send the data to PWM logic module 107.

Various data and control signal paths may couple PWM logic module 107, driver circuit 108, printhead 109, mechanical controller 123, beam detect sensor 112, and transfer belt position sensor 125. In some embodiments, printhead 109 may be a laser printhead. In some embodiments, beam detect sensor 112 may generate a start of scan (SOS) or “hsync” signal for each scan line in an image, or for a set of scan lines in an image, and send the generated signal to mechanical controller 123, which then sends the signal to PWM logic module 107.

Driver circuit 108 may be communicatively coupled to PWM logic module 107 and printhead 109. In some embodiments, scanning mirror 110 may be mechanically or electromagnetically coupled to scanning motor 111, which may be used to rotate scanning mirror 110. Each laser beam from printhead 109 may be transmitted to scanning mirror 110, and scanning mirror 110 may reflect that beam at different times to beam detect sensor 112 and optical system 113, which may include a cylindrical lens, an f-theta lens, a guide lens, and so on. Optical system 113 may guide laser beams from scanning mirror 110 to photosensitive drums 114. Drum charger 116 may be used to charge photosensitive drum 114. Although only one set comprising scanning mirror 110, scanning motor 111, and beam detect sensor 112 has been illustrated in FIG. 1, four sets of scanning mirror 110, scanning motor 111, beam detect sensor 112, and optical system 113 may be provided—one set for each of the four laser beams, respectively. In this case, each beam detect sensor 112 can generate an SOS signal.

In some embodiments, each latent image formed on photosensitive drum 114 may be developed with a toner at developing station 115 before transferring to paper 175. Paper 175 may be passed from paper input tray 126 through transfer rollers 124 to transfer belt 117, where toner images developed at developing stations 115 and accumulated on transfer belt 117 may be transferred to paper 175. After the image has been transferred, paper 175 may be moved over paper path 118 using transfer rollers 124 and past fuser 119, guide rollers 121, and to paper output tray 122. In some embodiments, fuser 119 may facilitate the fixing of the transferred image to paper 175.

In an exemplary embodiment, printer 100 may include a printer controller 180 and a printer engine 190. Printer controller 180 may be configured to process image data received from computer 200 via connection 120, and send the processed data to print engine 190 for printing. Printer controller 180 of printer 100 may include, among other things, a USB interface 102, a CPU 103, a memory 104, a control block 105, at least one decompressor module 106 with attached random access memory (“RAM”), at least one pulse width modulation (“PWM”) logic module 107, and at least one driver circuit 108. Exemplary printer engine 190 of printer 100 may include beam detect sensor 112, optical system 113, developing station 115, photosensitive drum 114, drum charger 116, scanning mirror 110, scanning motor 111, and printhead 109. The various modules and subsystems described above may be implemented by hardware, software, or firmware or by various combinations thereof.

In some embodiments, computer 200 may send image data to printer controller 180 over connection 120. The image data sent from the computer 200 may be compressed. In some embodiments, the compressed image data may be in a line-sequential compressed format. After the image data is received by USB interface 102, the image data may be placed in memory 104 under the control of CPU 103. In some embodiments, a print sequence may be initiated when image data for some portion of the page has been stored in memory 104. In some embodiments, mechanical controller 123 may initiate operations of scanning motor 110, photosensitive drum 114, and transfer belt 117 through appropriate data and/or control signals.

Beam detect sensor 112 can detect a laser beam's position and generate pulses (SOS signals) that are sent to printer controller 180 so that image data can be properly aligned from line to line in a printed image. In some embodiments, at the beginning of a scan of each line of the image, light from the printhead 109 may be reflected by scanning mirror 110 onto beam detect sensor 112. Beam detect sensor 112 may signal mechanical controller 123 which, in turn, may send an SOS signal to PWM logic module 107. In some embodiments, a separate signal typically referred to as top of data (TOD) or “vsync” may also be generated by mechanical controller 123, based on information received from transfer belt position sensor 125. The TOD or vsync signal indicates when image data transfer can begin for paper 175. For example, in some embodiments, a TOD signal may be sent to PWM logic module 107 via mechanical controller 123. Once the TOD signal is received, CPU 103 may initiate a transfer from memory 104 to de-compressor module 106. In some embodiments, decompressor module 106 may decompress image data and pass the resulting raw image data to PWM logic module 107. The resultant PWM pulses from PWM logic module 107 may then be streamed to driver circuit 108, which may then transmit the PWM pulses to printhead 109.

In some embodiments, laser beam from printhead 109 may be modulated and reflected off scanning mirror 110 and optical system 113, causing a latent image of charged and discharged areas to be built up on photosensitive drum 114. In some embodiments, toner develops this latent image at the developing station 115 and the toner image may be transferred to transfer belt 117. For a multi-component image, such as a color image, the latent image building process may repeat for each of the components. For example, for CMYK color printers the latent image building process on photosensitive drum 114 may be repeated for each of the colors C, M, Y, and K. Toner images for all four colors may be accumulated on transfer belt 117 before a complete toner image is transferred to the page at transfer roller 124.

In some embodiments, the latent image building process for each color plane on photosensitive drum 114 may be offset with respect to other color planes. For example, on a CMYK color printer, the physical offset between any two adjacent color planes may be 70 mm, so that the equivalent of 70 mm of image data for Y-plane may be transferred before the transfer of image data for M-plane is commenced. Because data for one or more color planes can be physically offset from data for another color plane, data for the one or more color planes may be transferred with a temporal offset relative to data for the other color plane. Thus, in one embodiment, if the physical offset between color planes is 70 mm, the equivalent of 70 mm of the physical offset data for one color plane can be transferred before beginning the transfer for the immediately succeeding color plane. Accordingly, there may be a temporal offset between individual color plane data transfers pertaining to the same print region.

In some embodiments, in sync with the timing when all components have been assembled on transfer belt 117, paper 175 may be fed from paper input tray 126 to transfer roller 124 where the image may be further transferred to paper 175. Fuser 119 may then fix the toner to paper 175, which is sent to paper output tray 122 using guide rollers 121. In some embodiments, the rate that the images are transferred to paper 175 (i.e., the print speed) may be determined by the rotational speed of transfer belt 117. For example, once the rotational speed is set for the transfer belt 117, the print speed may become constant and any delay in image data transfer to print engine 190 may cause video under-runs, and the page may not be printed properly.

A pixel clock generation module (not shown) may be a crystal oscillator or a programmable clock oscillator, or any other appropriate clock generating device. In some embodiments, such as in a “multi-pass” printer 100, which sends the video data for each color serially in sequence, the frequency of the clock generated by the pixel clock generation module may be fixed among each pass of the printer. In an example multi-pass printer 100, the pixel clock generation module may be a crystal oscillator. In another embodiment, such as a printer 100 that uses multiple sets of printheads 109 and developing stations 115, sometimes collectively referred to as a “tandem engine”, the frequency of each channel may be calibrated if the frequencies differ among the pixel clocks corresponding to each of the color components. In such embodiments, one or more programmable clock oscillators may be used to allow calibration.

Exemplary embodiments of printer 100 may include driver circuit 108 driving a printer engine 190, and the driver circuit 108 may be connected to multiple printheads 109. In some embodiments, printheads 109 could all be laser printheads. There may also be a plurality of individual modules of printer controller 180. For example, a single de-compressor module 106 may be connected to multiple PWM logic modules 107 with each PWM module 107 being connected to one or more pixel clock generation modules and one or more driver circuits 108. De-compressor module 106 and attached RAM could provide each PWM logic module 107 with one or more color components of an image, which would then be sent to the multiple driver circuits 108 for onward transmission to printer engine 190.

In other embodiments, multiple decompressor modules 106 may be coupled to multiple PWM logic modules 107. Each decompressor module 106 may provide a PWM logic module 107 with a decompressed component of the image. For example, for a multi-component image in CMYK color space, which contains cyan (“C”), magenta (“M”), yellow (“Y”), and black (“K”) image components, each individual image component may be processed by each de-compressor module 106 and sent down to each corresponding PWM logic module 107 in a parallel manner.

In some embodiments, printer 100 may have multiple lasers per laser printhead 109. In some embodiments, printhead 109 may receive multiple lines of data from driver circuit 108 and project the multiple lines of data to scanning mirror 110. Scanning mirror 110 may then reflect the multiple lines of data to beam detect sensor 112 and optical system 113, which may reflect the multiple lines to photosensitive drum 114. In some embodiments, the beam detect sensor 112 may detect a signal, such as a laser signal, reflected off of the scanning mirror 110, or may also detect multiple signals reflected off scanning mirror 110.

Each of the logical or functional modules described above for printer 100 may comprise multiple modules. The modules may be implemented individually or their functions may be combined with the functions of other modules. Further, each of the modules may be implemented on individual components, or the modules may be implemented as a combination of components.

Exemplary computer 200 may be a computer workstation, desktop computer, laptop computer, or any other computing device capable of being used with printer 100. In some embodiments, exemplary computer 200 may include, among other things, processor 280, memory 281, a data transfer interface such as exemplary USB interface 282, and user input interface 283. Processor 280 may be a central processing unit (“CPU”). Depending on the type of computer 200 being used, processor 280 may include one or more printed circuit boards, and/or a microprocessor chip. Processor 280 may execute sequences of computer program instructions to perform various processes including processes for print data processing and compression. The computer program instructions may be accessed and read from memory 281, or any other suitable memory location, and be executed by processor 240. Memory 281 may be any type of Dynamic Random Access Memory (“DRAM”) such as, but not limited to, SDRAM, or RDRAM.

In one exemplary embodiment, computer 200 may include USB interface 282 capable of sending and receiving data via a serial pipe. For example, USB interface 282 may be coupled to processor 280 to receive data to be printed and may send the data to printer 100 via connection 120. It is contemplated that other interfaces may also be used to send data via other types of connections 120. For example, the interfaces can include, parallel port, FIREWIRE, and/or wireless interfaces.

Data under-runs may be prevented by transferring a full page of image data from computer 200 to printer 100 at speeds not less than the print speed of printer 100. In one embodiment, a color data compression application, such as a color data resolution switching application, may be included in computer 200 to appropriately reduce the size of the color image data and permit image data transfers without exceeding the available bandwidth of connection 120. In some embodiments, the resolution switching application may run on computer 200. It is also contemplated that the resolution switching application may be stored on a removable computer readable medium, such as a hard drive, computer disk, CD-ROM, DVD ROM, CD±RW or DVD±RW, USB flash drive, memory stick, or any other suitable medium.

In some embodiments, image data may be divided into blocks termed image blocks, which can be as small as individual lines of the image. Color images are normally represented in a color space, such as CMYK, comprising of component color planes. For color image data, an image block may comprise color blocks corresponding to the constituent color components of the color image. Consistent with disclosed embodiments, a print frame refers to the set of color blocks corresponding to the same region of the image. During the printing process, toner images of the color blocks in a print frame may be printed in the same region on the print medium. For example, in a CMYK color printer, each print frame may comprise of color blocks corresponding to the C, M, Y, and K component color planes. On the other hand, a transfer frame refers to a set of color blocks that are transferred together. In some embodiments, these color blocks may share a portion of the available bandwidth offered by connection 120.

In some color printers, color blocks corresponding to the constituent color planes of a single print frame may be physically offset with respect to each other when they are transferred. Thus, a color block for one color plane in a print frame may be transferred with a temporal offset to a color block for another color plane in the same print frame. For example, the physical offset between any two adjacent color planes may be 70 mm, so that the equivalent of 70 mm of image data for Y-plane 10 may be transferred before the transfer of image data for M-plane 20 is commenced. Accordingly, there may be a temporal offset between individual color plane data transfers pertaining to the same print frame. As a result, at various points during the printing process a transfer frame may include less than the entire set of color planes so that a proportionally higher bandwidth may be available for each color plane.

User input interface 283 may be provided for user 300 to input information and/or control instructions into computer 200, and may include, for example, a keyboard, a mouse, and/or optical or wireless computer input devices. For example, user 300 may initiate or stop a print task via user input interface 283. In some embodiments, user interface 283 may permit user 300 to specify high quality printing for one or more print areas in document. In some embodiments, areas for high quality printing may be specified by placing markers in the document, or by various other techniques.

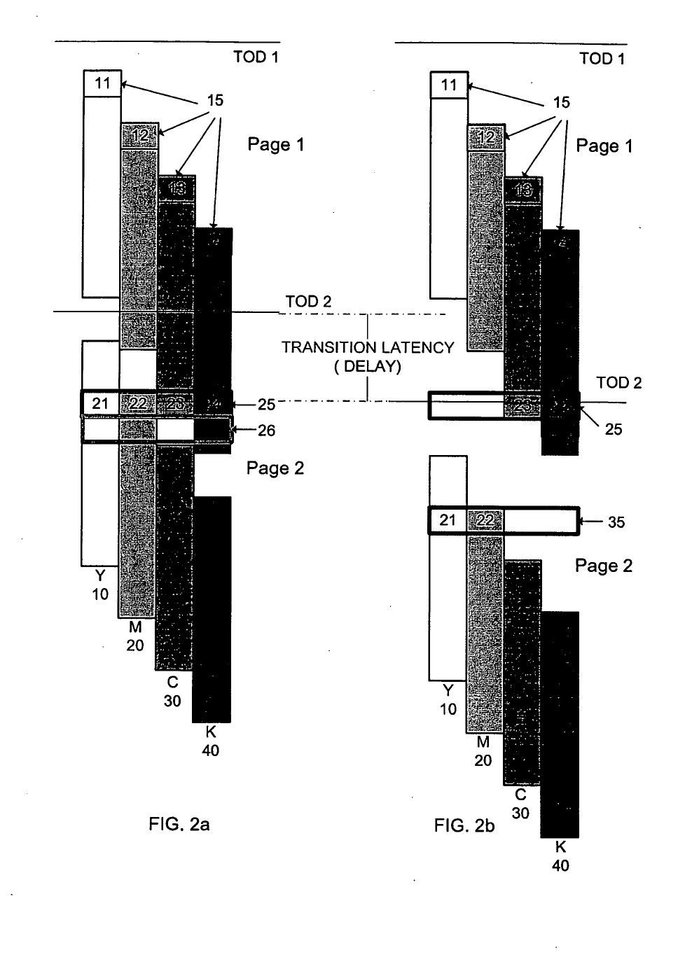

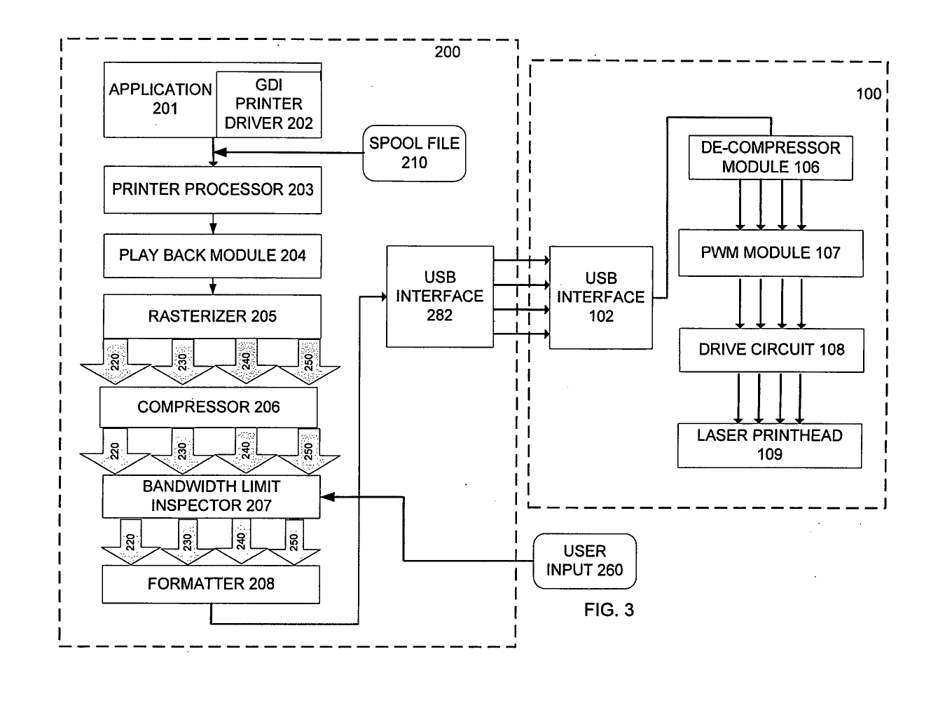

FIG. 2a illustrates two consecutive print pages transferred from an exemplary computer 200 to an exemplary printer 100. As shown in FIG. 2a, for exemplary CMYK color printer 100, which uses cyan (“C”), magenta (“M”), yellow (“Y”), and black (“K”), color image data for Y-plane 10 may start transferring first, followed by image data for M-plane 20, C-plane 30 and K-plane 40, respectively. For example, there may be a temporal offset between the transfer of print frame data from two distinct color planes. For example, data transfer for the Y-plane may start earlier based on the time duration associated with the physical offset. If the physical offset between planes is 70 mm then data equivalent to a physical offset of 70 mm of image data for Y-plane 10 may be transferred before the transfer of image data for M-plane 20 is commenced.

For example, as shown in FIG. 2a exemplary print frame 15 at the beginning of a page, such as exemplary page 1, can comprise color block 11 of Y-plane 10, color block 12 of M-plane 20, color block 13 of C-plane 30, and color block 14 of K-plane 40. Color blocks 11-14 correspond to the same region of a print page, but may be offset with respect to each other during transfer. Note that in FIGS. 2a and 2b, exemplary pages 1 and 2 represent any two consecutive pages that are printed in sequence and page identifiers 1 and 2 are used for descriptive purposes only.

When multiple print pages are transferred, due to the temporal offset among the color planes, a transfer frame at the transitional region between two consecutive pages can include color blocks associated with both pages. The transition region may be defined as the region between two consecutive pages (during conventional data transfer) starting from the period when the transfer frame for the first color block in the last print frame on the earlier page has completed transfer and ending when the transfer frame for the last color block in the first print frame on the immediately succeeding page begins transfer.

As shown in FIG. 2a, exemplary transfer frame 25 is in the transitional region between page 1 and page 2, and it comprises color blocks 21 through 24 that are transferred during the same time interval. Transfer frame 25 may comprise color block 21 of Y-plane 10, color block 22 of M-plane 20, both from page 2, and color block 23 of C-plane 30, and color block 24 of the K-plane 40, both from page 1. Since data for Y-plane 10 and M-plane 20 is transferred before data for the other two color planes, color blocks 21 and 22 may include image data from page 2, while image data from page 1 for other planes in the same transfer frame is still being transferred.

In a CMYK color printer, for example, color image data of Y-plane may start transferring first, followed by image data of M-plane, C-plane, and K-plane, respectively. Therefore, the transferring of the Y-plane color image data associated with the first print page may be completed first. Due to blank areas corresponding to the bottom margin of the first page and the top margin of the second page, there may be a period of latency prior to transferring Y-plane color image data associated with the second print page. Therefore, the transfer frames may not include Y-plane data during the page transition latency period.

In some embodiments, if the transitional region between the first page and the second page is sufficiently large (e.g., the bottom margin of the first page and/or the top margin of the second page are sufficiently large), certain transfer frames may include image color data from less than all four color planes. For example, as shown in FIG. 2a, exemplary transfer frame 26 may include color blocks from Y-plane 10, M-plane 20, and K-plane 40, but not C-plane 30. As a result, a proportionally higher bandwidth may be available for the other color plane data in these transfer frames. In some embodiments, the increased bandwidth available for color plane data transferred during the page transition latency period may permit higher resolution color blocks to be transferred. For example, the three color blocks that constitute transfer frame 26 may use the entire bandwidth of connection 120 for some time period.

In some embodiments, the transitional region may be effectively expanded by increasing the spacing between two successive print pages, thereby increasing the page transition latency period or transition delay. For example, the real TOD signal may be delayed by print engine 190 under instructions from print controller 180, and equivalently a “pseudo” top margin may be created for the second page. In some embodiments, data transfer for a page may commence after color image data for all color planes for an immediately preceding page has been transferred. For example, for a CMYK color printer (where color plane data transfers can be relatively offset and transferred in Y-M-C-K order), the transferring of the Y-plane color image data associated with a print page may start after the transfer of K-plane color image data associated with the immediately preceding page has completed. Accordingly, the resolution of compressed color blocks associated with transfer frames in the expanded transitional region may be increased without exceeding the available bandwidth of connection 120.

For example, FIG. 2b illustrates two consecutive print pages transferred from an exemplary computer 200 to an exemplary printer 100, with an increased transition delay between page 1 and page 2. As a result of the increased transition delay, exemplary transfer frame 25 now includes color block 23 of C-plane 30 and color block 24 of the K-plane 40, but does not include color blocks from Y-plane 10 or M-plane 20. As shown in FIG. 2b, color block 21 of Y-plane 10 and color block 22 of M-plane 20 now constitute transfer frame 35. Due to the increased delay, in the example shown, no transfer frames include colors blocks from both page 1 and page 2.

Therefore, as a result of the increased transition delay, for the example in FIG. 2b, when transfer frame 25 and transfer frame 35 are transferred from computer 200 to printer 100, the available bandwidth of connection 120 may be shared by just two color blocks, instead of four. That is, the bandwidth available to each color block in transfer frame 25 and transfer frame 35 as shown in FIG. 2b may be double of that available to each color block in transfer frame 25 as shown in FIG. 2a. Accordingly, higher resolution image data for color blocks 21-24 may potentially be transferred in the embodiment shown in FIG. 2b.

In some embodiments, the transition delay may be adjustable and permit design tradeoffs between the needs for image quality and print speed. In some embodiments, the page transition latency period or transition delay may be user-specifiable through an appropriate user interface associated with a print driver. For example, the page transition latency period may be increased if higher image quality is desired for the current print task.

In some embodiments, the spacing between two successive print pages may be increased based on user selections or specifications. For example, an increased transition delay prior to transferring data for the second page may be specified by a user 300 via user input interface 283. In some embodiments, user 300 may desire higher image quality and may specify an increased transition delay between pages. In some embodiments, the transition delay may be determined automatically by computer 200 based on user selections and system parameters. In some other embodiments, the transition delay may be adjusted by user 300 via user input interface 283.

In some embodiments, user 300 may be able to select one or more color planes for printing with as high an image quality as possible. For example, user 300 may select one or more color planes using a GUI displayed on the screen of computer 200, using user input interface 283. For a CMYK color printer, user 300 may specify that K-plane data be printed with higher resolution when additional bandwidth is available. Accordingly, in some embodiments, a succeeding print page (such as exemplary page 2) may be delayed to permit image data of specified color planes (in exemplary page 1) to be transferred at a higher resolution.

FIG. 3 shows a block diagram indicating an exemplary data flow between an exemplary computer and an exemplary printer for color data compression. In an exemplary embodiment, a print job may be initiated by an application 201 running on computer 200. For example, application 201 may use a graphic device interface (“GDI”) and printer driver 202 to generate a description of the print job. The description may include the image data to be printed, such as a letter or a picture, and formatting and printing instructions that form the image data into a properly printed page. In some embodiments, application 201 may use GDI and printer driver 202 to format the description in the form of meta-data and generate a print spool file 210.

The size of the image data may vary depending on the number of color planes associated with the data and the resolution of the image. In some embodiments, the image data may include multiple components associated with multiple color planes. For example, the components in a CMYK image may be processed and/or transferred one after another, or in a parallel manner. In some embodiments, the formatting and printing instructions may be created and stored as a header file of print spool file 210. The size of the header file may be relatively constant among various print jobs.

In some embodiments, the generated print spool file 210 may be sent to a printer processor 203 on computer 200. Printer processor 203 may perform tasks such as collating on print spool file 210 before it is sent off to a playback module 204 for playback. In some embodiments, playback module 204 may create a list of simple objects that can be rasterized by rasterizer 205, based on the GDI description in print spool file 210.

Print spool file 210 may then be sent to a rasterizer 205. Rasterizer 205 may be configured to transform the image data in print spool file 210 into bitmap data. Rasterizer 205 may further include a frame buffer that contains rasterized bitmap data. In some embodiments, rasterizer 205 may transform the image data in portions, when the size of the image data is relatively large. In some embodiments, computer 200 may include a plurality of rasterizers configured to rasterize color data into a plurality of bitmaps. For example, as shown in FIG. 3, rasterizer 205 may be able to rasterize C-plane color data 220, M-plane color data 230, Y-plane color data 240, and K-plane color data 250 in parallel. In some embodiments, rasterizer 205 may include sub-rasterizer modules corresponding to individual color planes, where each sub-rasterizer module may operate on data in its respective color plane.

Consistent with one embodiment of the present disclosure, rasterizer 205 may be further configured to compute a lower resolution image and a delta image for image data in each color plane. For example, the original image data in print spool file 201 may have a resolution of 600 dpi. Rasterizer 205 may compute a lower resolution image that have a resolution of 480 dpi and a delta image that represents the difference information between the original image and the lower resolution image. In some embodiments, the delta image may include a portion of the original high resolution image data. In some embodiments, the delta image can be used to recover the original higher resolution image when used in conjunction with the lower resolution image. The computation used to compute the delta image may be mathematically reversed to reconstruct the original image from the lower resolution image and the delta image.

In some embodiments, resolution may be reduced in only one physical dimension. For example, resolution may be reduced only in the main scanning direction (i.e., perpendicular to the direction in which paper is fed to a printer) so that the image data transfer rate keeps up with print speed. For example, if paper is fed to the printer along its length (i.e. vertically) then resolution may be reduced in the horizontal direction. In some embodiments, resolution may be reduced in both dimensions (horizontal and vertical). Various algorithms may be used to compute the lower resolution image and the delta image, such as applying low-pass and high-pass filters to the original image.

Rasterized image data (bitmap data) may be compressed by compressor 206. Compression may reduce the size of the image data, and therefore reduce the bandwidth for transferring the image data. In some embodiments, compressor 206 may use lossless compression methods such as, for example, JBIG and GIF compressions, so that the image may be reconstructed without loss in quality by decompression at decompressor module 106. In some other embodiments, compressor 206 may use lossy compression methods such as, for example, JPEG and wavelet compressions. In some embodiments, compressor 206 may also be configured to use a combination of various compression algorithms.

In some embodiments, computer 200 may include a plurality of compressors configured to compress color data in the color planes. For example, as shown in FIG. 3, compressor 206 may include four sub-compressors for compressing C-plane color data 220, M-plane color data 230, Y-plane color data 240, and K-plane color data 250 in parallel. In some embodiments, the same compression algorithm and parameters may be applied to color data in all the color planes.

Compressed color data may be passed from compressor 206 to a bandwidth limit inspector 207. Bandwidth limit inspector 207 may be configured to determine if the bitmap image can be sent across connection 120 without exceeding the bandwidth of connection 120. In some embodiments, bandwidth limit inspector 207 may make its determination on a transfer frame by transfer frame basis, depending on the size of the buffers in printer controller 180 and/or on the granularity of the resolution switching scheme. For example, for the smallest granularity, the transfer frame may be a line of the bitmap image. Each transfer frame may include a plurality of compressed color blocks.

In some embodiments, bandwidth limit inspector 207 may receive a user input 260. For example, user input 260 may be input by user 300 via user input interface 283. User input 260 may include selections that specify increased spacing between two successive print pages. In some embodiments, user input 260 may also include a specification of one or more areas on the print pages that are to be printed with as high image quality as possible. Each specified area may include one or more print frames. For example, user 300 may specify a color image on the print page to be printed with high image quality. The color image may include one or more print frames and each print frame may include a plurality of color blocks. Bandwidth limit inspector 207 may determine a transition delay such that the original resolution of these color blocks may be retained during the transfer via connection 120.

In some embodiments, bandwidth limit inspector 207 may determine the transition delay based on the position of the specified areas. For example, if the specified area is near the bottom of a first print page, bandwidth limit inspector 207 may increase the transition delay between the end of the first page and the start of the second page so that transfer of image data for the first color-plane in the second page does not start until the image data for the specified area has been transferred. As another example, if the specified area is near the top of a second page, bandwidth limit inspector 207 may delay the start of the second page so that image data for the last color-plane in the first page has been transferred prior to the initiation of image data transfers for the specified area.

In some embodiments, user input 260 may further include a specification of one or more color planes that are to be printed with as high image quality as possible. For example, the specified color planes may be associated with high resolution image data or important image information. Therefore, it may be desired that the color blocks associated with these specified color-planes may be printed with as high resolution as possible. In some embodiments, bandwidth limit inspector 207 may determine the transition delay based on the transfer order of the color planes. For example, for a CMYK color printer, if K-plane data is specified as higher-resolution data by user 300, then bandwidth limit inspector 207 may delay the start of the second print page so that transfer of Y-plane image data for the second page does not start until K-plane image data for the first page has been transferred.

In some embodiments, after the transition delay is determined, bandwidth limit inspector 207 may determine the color blocks constituting a transfer frame based on temporal offsets between color planes and/or the transition delay between two successive print pages.

For each transfer frame, bandwidth limit inspector 207 may determine the order of color plane transfer, and the color planes involved in the transfer frame. For example, for CMYK color printers, image data transfer may start from Y-plane 10, followed by M-plane 20, C-plane 30, and K-plane 40. Note that individual color blocks in a single print frame may be physically and temporally offset. For example, the offset between successive color planes may correspond to 70 mm of printed page data. Therefore, starting at time 0 and for the duration of the first 70 mm offset, color block image data transferred via connection 120 may correspond to Y-plane data. For the duration of the next 70 mm offset (from 70 mm to 140 mm), color block image data transferred may correspond to both Y-plane and M-plane data. During the period associated with the next 70 mm offset (from 140 mm to 210 mm), color block image data transferred may correspond to Y-plane, M-plane, and C-plane data. After a time duration corresponding to a 210 mm offset from time 0 (or the start of Y-plane color block data transfer), transfer frames may contain image data of all four color planes.

For a transfer frame in the transition region between two consecutive print pages, bandwidth limit inspector 207 may process color block data conventionally or may increase the transition latency. If transition latency is increased, then the processing of color block data for the first print frame in the second page may occur at a later point during processing than in the conventional case. For example, in a CMYK printer, the second page may be delayed to the extent that color block transfers for Y-plane image data for the first print frame in the second page may commence after color block transfers for K-plane image data for the last print frame in the first page have completed.

Therefore, if the color blocks for a print frame are physically offset by 70 mm, then for the duration of the last 70 mm of the first page, image data transferred via connection 120 may correspond to K-plane data. For the 70 mm equivalent time duration immediately preceding the K-plane data for the first print page above, image data transferred may correspond to both C-plane and K-plane data. Similarly, for the 70 mm equivalent time duration immediately preceding the C- and K-plane data transfer for the first print page above, image data transferred may correspond to M-plane, C-plane data, and K-plane. For time durations immediately preceding the M-plane, C-plane data, and K-plane data transfer for the first page above, transfer frames may contain image data from all four color planes.

In some embodiments, bandwidth limit inspector 207 may also determine the compressed color blocks present in the transfer frame. For example, bandwidth limit inspector 207 may also determine that K-plane color block 24 and C-plane color block 23, which are part of exemplary transfer frame 25, are both compressed.

In some embodiments, bandwidth limit inspector 207 may then inspect the transfer frame and determine the cumulative size of all compressed color blocks in the transfer frame. Bandwidth limit inspector 207 may then compare the cumulative data size with a data-size threshold. According to one embodiment, the data-size threshold may be determined based on the print speed of printer 100 and the available bandwidth of connection 120. In some embodiments, bandwidth limit inspector 207 may tag one or more compressed color blocks in transfer frame 25 for further resolution reduction, if transfer frame 25 has a data size that is larger than the data-size threshold. In some embodiments, additional resolution reductions of tagged color blocks may be performed by formatter 208.

In some embodiments, bandwidth limit inspector 207 may compare the data size of the compressed block in each color plane with a sub-channel data-size threshold. Sub-channel bandwidth allocations for the various color planes may be specified as a percentage or fraction of the available bandwidth. In one embodiment, the sub-channel data-size threshold for a color plane may be determined based on the print speed of printer 100 and the sub-channel bandwidth allocated to the color plane. The bandwidth available for a given sub-channel is inversely proportional to the number of color blocks in a transfer frame. For example, if connection 120 has a bandwidth of 60 M bytes per second, a bandwidth of 15 M bytes per second may be allocated to each color plane sub-channel if the transfer frame includes four color blocks. On the other hand, if the transfer frame includes two color blocks, the color plane sub-channel bandwidth can be 30 M bytes per second.

In some embodiments, bandwidth limit inspector 207 may tag a compressed block in the transfer frame for resolution reduction, if the respective data size of the compressed block is larger than the sub-channel data-size threshold. In some embodiments, bandwidth limit inspector 207 may tag a compressed block in the transfer frame for resolution reduction, if the data size of the compressed block is larger than the sub-channel data-size threshold even after the page transition delay has been increased to a user, system, and/or design specified maximum.

In some embodiments, instead of having user 300 specify the transition delay between every two successive print pages, bandwidth limit inspector 207 may automatically determine the transition delay based on the image data. For example, bandwidth limit inspector 207 may first determine the compressed color blocks that constitute a transfer frame in the transitional region, without increasing the conventional transition delay between two successive print pages. Bandwidth limit inspector 207 may then compare the total data size of compressed blocks in the transfer frame with the data-size threshold. If the total data size of the transfer frame is larger than the data-size threshold, bandwidth limit inspector 207 may compute an increased transition delay for the second page.

In some embodiments, bandwidth limit inspector 207 may compare the duration for transferring the frame with the available bandwidth with a maximum delay specified by system parameters or by the user. If the duration exceeds the maximum delay then one or more blocks in the frame may be compressed further or reduced resolution such that data under-run may be avoided. If the computed duration permits transfer under the specified parameters then the transition delay may be increased appropriately.

In some embodiments, bandwidth limit inspector 207 may iteratively increase the transition delay for the second page until (i) the transfer frame being processed does not exceed the bandwidth available over connection 120, or (ii) the increased transition delay exceeds a maximum transition delay threshold, whichever condition occurs first.

Compressed color image data may be further passed from bandwidth limit inspector 207 to a formatter 208. Formatter 208 may be configured to accumulate one full image in memory before passing it to USB interface 282 and transferring to printer 100. Consistent with disclosed embodiments, formatter 208 may be further configured to examine if a color block received from bandwidth limit inspector 207 is tagged. If a color block is tagged, formatter 208 may remove the delta image block that is associated with the tagged color block.

In some embodiments, formatter 208 may discard delta image blocks for all color planes in a print frame, if a color block corresponding to any one color plane in that print frame is tagged. For example, on a CMYK color printer, formatter 208 may examine print frame 15 that contains constituent color blocks 11-14 corresponding to Y, M, C, K planes respectively. If one of the constituent color blocks of frame 15 is tagged, then print frame 15 is considered as tagged, and formatter 208 may discard delta image blocks for all the C, M, Y, and K planes.

For a color block that is not tagged, formatter 208 may reconstruct the color block based on the corresponding portions of the compressed lower resolution image and the compressed delta image. Formatter 208 may then buffer one full image in the memory, and the buffered image can include color blocks of reduced resolution and color blocks of original resolution. Formatter 208 may transfer the buffered image across connection 120 using USB interfaces 102 and 282.

In some embodiments, the compressed image data may be decompressed by de-compressor module 106 using decompression algorithms. In some embodiments, de-compressor module 106 may pass the decompressed image data to PWM logic module 107. The resultant PWM pulses from PWM logic module 107 may then be streamed to driver circuit 108, which may then transmit the PWM pulses to printhead 109. In some embodiments, PWM logic module 107, therefore, may be construed to be able to dynamically switch itself in either a high resolution mode (for 600-dpi-driving) or a low resolution mode (for 480-dpi-driving) color block by color block basis. Any conventional method or mechanism may be deployed for switching of the operation mode of PWM logic module. Accordingly, images may be decompressed color block by color block and may have differing resolutions. For example, one color block may have a resolution of 480 dpi, while another color block may have a resolution of 600 dpi.

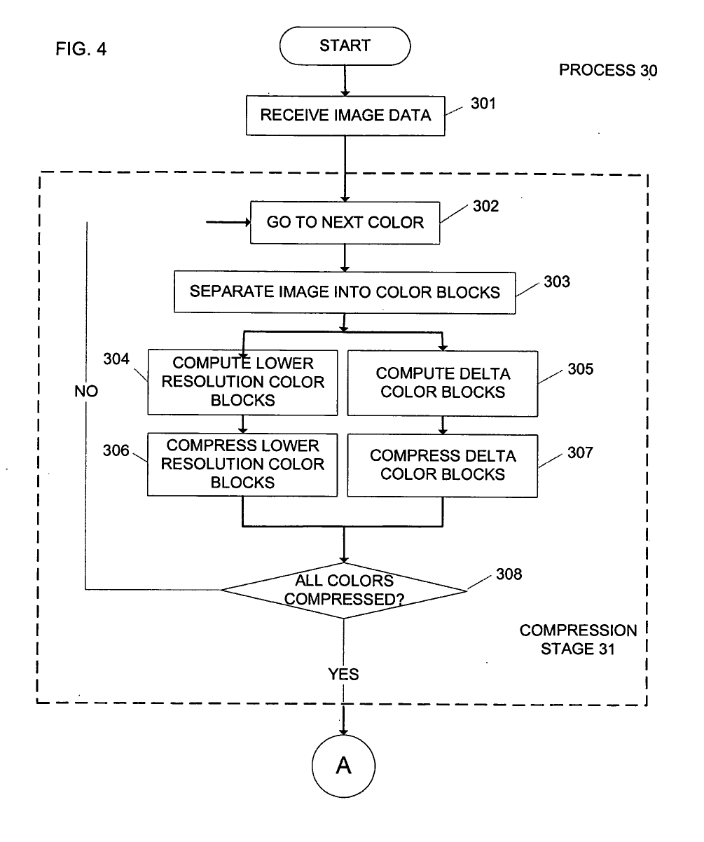

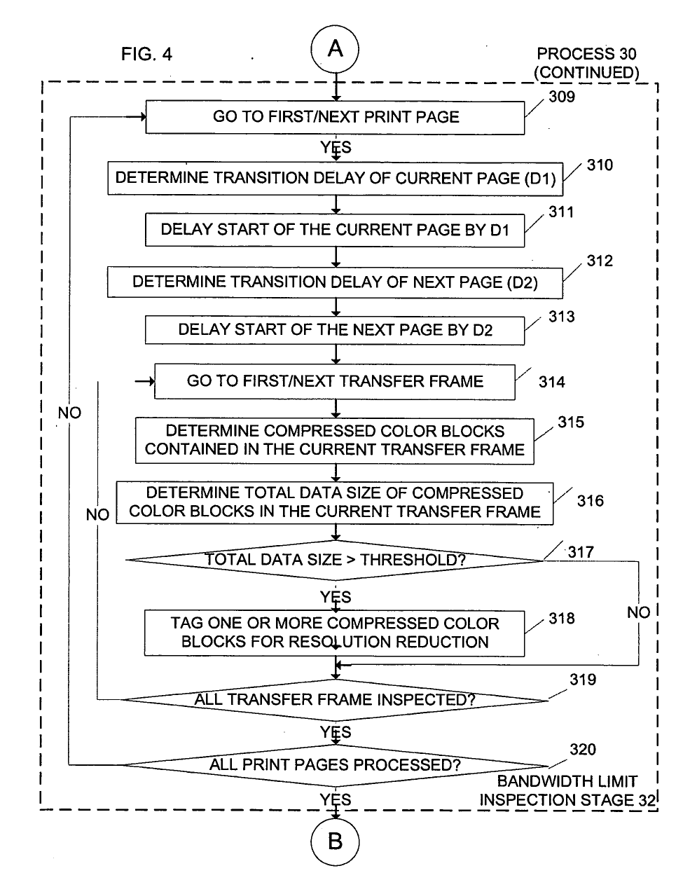

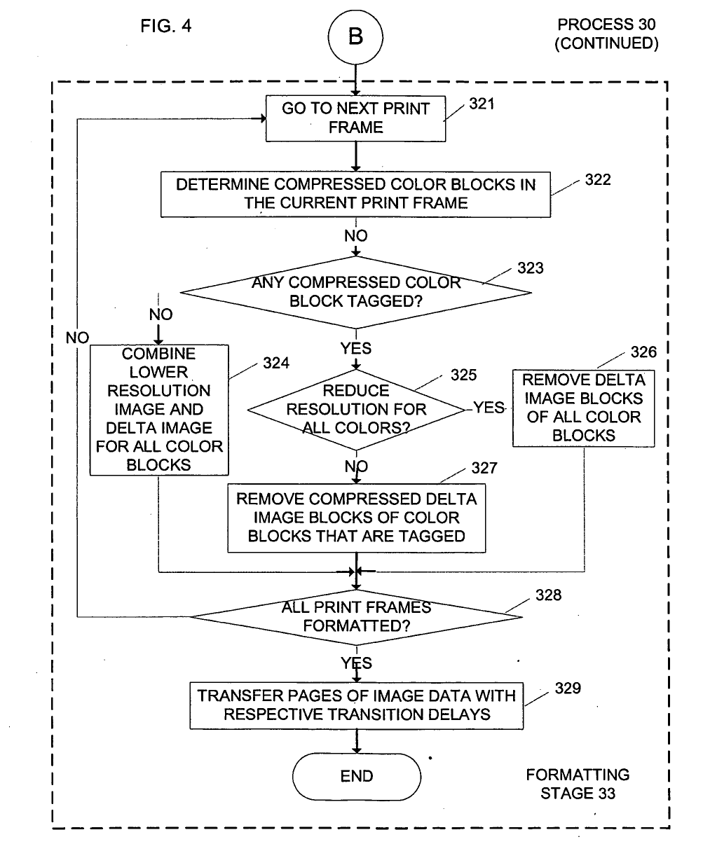

FIG. 4 shows a flow chart of an exemplary resolution switching operation process 30 according to the disclosed embodiments. The algorithm described in FIG. 4 may also be applied to various other types of printing systems such as, for example, copiers and multi-function devices, with appropriate modifications specific to the device and in a manner consistent with embodiments disclosed herein. The algorithm described in FIG. 4 may further be used in conjunction with various software applications to perform resolution switching.

In step 301, image data may be received. For example, application 201 may generate a print spool file 210 that contains print image data and printing instructions, and print spool file 210 may be received by printer processor 203 from application 201. In some embodiments, the image data may include multiple components associated with multiple color planes. In some embodiments, the image data may be associated with multiple print pages.

Compression stage 31 of process 30 may comprise steps 302-308. In step 302, image data of the first or next color plane may be compressed. In step 303, the image of the current color plane may be separated into color blocks. In some embodiments, the granularity of the color blocks may be as small as individual lines of the image for the current color plane.

Based on the image data in each color block, a lower resolution color block may be computed in step 304 and a corresponding delta color block may be computed in step 305. For example, a lower resolution color block with a resolution of 480 dpi may be computed from an original color block with a resolution of 600 dpi. A corresponding “delta” color block (with information corresponding to the 120 dpi of reduced resolution) may also be computed simultaneously. The delta color block may represent difference information between the original color block and the lower resolution color block. The computation of delta color block may be mathematically reversed to reconstruct the original color block from the lower resolution image and the delta image.

After the lower resolution color block and the delta color block are computed in step 304 and 305, both images may be compressed in step 306 and step 307. For example, the images may be compressed by compressor 206. In step 308, it may be determined whether all the color planes have been processed by the computer. If there is still at least one color plane of the print image left unprocessed, the algorithm may go back to step 302 and process the next color plane. The algorithm can iterate through steps 302-308 until all the color planes have been compressed, after which, compression stage 31 may conclude.

In some embodiments, bandwidth limit inspection stage 32 may begin after the images are compressed. In bandwidth limit inspection stage 32, it may be determined if a transfer frame can be sent across connection 120 without exceeding the available bandwidth of connection 120. In some embodiments, the transition delay may be increased between two or more consecutive print pages, based on user preferences to preserve quality of the print image. Accordingly, bandwidth limit inspection stage 32 may determine the amount of delay.

If the print task includes multiple print pages, a “virtual” page may be formed by stacking consecutive print pages. Consistent with the present disclosure, “stacking” two print pages refers to placing the second print page immediately after the first print page, so that the top of the second print page occurs immediately after the bottom of the first print page. In some embodiments, multiple pages may be stacked to form a virtual page, and methods similar to those described above for a single page may be used to determine compressed color blocks in a transfer frame for the virtual page.

In step 309, the first or the next print page may be processed. In step 310, a transition delay for the current page (D1) may be determined. Transition delay D1 refers to the time difference between the originally scheduled transfer of the current print page and the computed or actual time that the current print page is transferred. In some embodiments, user 300 may specify one or more areas on print pages that are to be printed with as high image quality as possible. Accordingly, in step 310, it may be determined if any of these areas are in the transitional region between the current print page and the previous print page.

If at least one specified area is in the transitional region, transition delay D1 may be determined based on the positions of the specified areas. In some embodiments, the transition delay D1 may be computed as the larger of D1′ and D1″. D1′ and D1″ represent two ways of computing transition delays. D1′ can be computed by calculating the transition delay for the situation where transfer of color blocks corresponding to the current page is delayed until the transfer of all the color blocks associated with the specified areas (in the transition region) of the immediately preceding page has completed. D1″ can be computed by calculating the transition delay for the situation where transfer of color blocks associated with the specified areas (in the transition region) of the current page is delayed until the transfer of all color blocks of the immediately preceding page has completed.

In some embodiments, user 300 may specify one or more color planes that are to be printed with as high image quality as possible. Accordingly, D1′ can be computed by calculating the transition delay for the situation where the transfer of color blocks corresponding to the current page may be delayed until the transfer of all the color blocks associated with the specified color planes of the immediately preceding page has completed. D1″ can be computed by calculating the transition delay for the situation where the transfer of color blocks associated with the specified color-planes of the current page may be delayed to allow the transfer of all the color blocks of the immediately preceding page to complete.

For example, on a CMYK color printer, where Y-plane transfers first, followed by M-plane, C-plane and K-plane, user 300 may specify that K-plane be printed with as high resolution as possible. Accordingly, the transfer of current page may be delayed by transition delay D1 such that the Y-plane image data of the current print page does not start transferring until the transfer of K-plane image data in the immediately preceding page has completed.

In some embodiments, the computed transition delay D1 may be compared with a maximum transition delay. If D1 exceeds the maximum transition delay, it may be reset as the maximum transition delay and further compression of color blocks may be performed to ensure that the data can be transferred using the available bandwidth in the duration available. The maximum transition delay may be specified by system parameters or by the user based on the physical parameters of printer 100 and the available bandwidth connection 120. Alternatively, the maximum transition delay may be determined based on the temporal offsets among successive color planes as well as the top and bottom margins of the print pages. For example, the maximum transition delay may be determined according to the formula that Maximum Transition Delay=(N×Time Duration corresponding to the of Physical Offset between consecutive color planes)−Top Margin−Bottom Margin, where N is the number of color planes.

In step 311, the transfer of the current print page may be delayed by D1 compared to its originally scheduled transfer time with respect to the transfer of the immediately preceding page. That is, transfer of all the color blocks associated with all the color planes of the current print page may be delayed by the same time period D1. In step 313, a transition delay of the immediately succeeding print page (D2) may be determined. Similar to step 310, when user 300 specifies one or more areas on print pages that are to be printed with as high image quality as possible, it may be determined in step 312 if any of these areas are in the transitional region between the current print page and the immediately succeeding print page.

If at least one specified area is in the transitional region, transition delay D2 may be determined based on the positions of the specified areas. In some embodiments, the transition delay D2 may be computed as the larger of D2′ and D2″, where D2′ and D2″ may be determined in a similar manner as D1′ and D1″ above. The determined D2 may also be reset to the maximum transition delay, and if D2 exceeds the maximum transition delay. In step 313, the transfer of the immediately succeeding print page may be delayed by D2 compared to its originally scheduled transfer time with respect to the transfer of the current page. That is, transfer of all the color blocks associated with all the color planes of the current print page may be delayed by the same time period D2.

In step 314, the first or the next transfer frame may be inspected. In some embodiments, in step 315, compressed color blocks of all colors that are in the current transfer frame may be determined. In some embodiments, bandwidth limit inspector 207 may determine compressed color blocks of all color planes in the current transfer frame. For example, bandwidth limit inspector 207 may first determine the color planes involved in the current transfer frame, and then determine which compressed color blocks associated with these color planes are contained in a transfer frame.

In some embodiments, in step 316, the cumulative size of compressed color blocks in the current transfer frame may be determined. For example, total pixel count of compressed color blocks, including their respective lower resolution image blocks and delta image blocks, may be determined by bandwidth limit inspector 207. In step 317, the total data size may be compared with some pre-determined threshold. According to one embodiment, the threshold may be determined based on the print speed of printer 100 and the bandwidth of connection 120.

In step 317, if the total data size exceeds the threshold, one or more compressed color blocks in the current transfer frame may be tagged with a delta removal flag in step 318. In some embodiments, the delta removal flag may indicate that the delta image block corresponding to the compressed color block tagged should be removed.

In some embodiments, alternative algorithms may be used for steps 316-318 shown in FIG. 4. For example, bandwidth limit inspector 207 may determine data size of each compressed color block in the current transfer frame, in step 316. Bandwidth limit inspector 207 may then compare the data size of each compressed color block with a corresponding sub-channel threshold for that color plane, in step 317. In step 318, the compressed color block in the transfer frame may be tagged with a delta removal flag, if the respective data size of the compressed color block is larger than the sub-channel threshold.

In step 317, if the total data size does not exceed the threshold, step 318 may be skipped and process 30 may proceed directly to step 319. In step 319, it may be determined whether all the transfer frames associated with the current print page have been inspected. If there is still at least one transfer frame left uninspected, the algorithm may go back to step 314 and inspect the next transfer frame. The algorithm can iterate through steps 314-319 until all the transfer frames have been inspected. For example, bandwidth limit inspector 207 may go through each transfer frame in the image.

In step 320, it may be determined whether all the print pages have been processed. If there is still at least one print page left uninspected, the algorithm may go back to step 309 and process the next print page. The algorithm can iterate through steps 309-320 until all the transfer frames have been inspected.

A formatting stage 33 may begin after all the transfer frames in the image are inspected and properly tagged. For example, formatting stage 33 may accumulate a full image before the image is sent to a printing device. In some embodiments, formatting may also be done on a color block by color block basis. In step 321, the first or next print frame may be accessed. In step 322, compressed color blocks of all colors in the current print frame may be determined. In the example shown by FIG. 2a and FIG. 2b, bandwidth limit inspector 207 may determine that print frame 15 contains color blocks 11-14. In step 322, it may be determined if a delta removal flag is associated with any compressed blocks in the current print frame.

In step 323, if the delta removal flag has not been set for any of the color planes in the current print frame, no resolution reduction may be performed. Accordingly, in step 324, the compressed color blocks may be reconstructed based on the corresponding portions of the lower resolution image and the delta image. If in step 323 the delta removal flag has been set for at least one color plane in the current printing frame, a determination whether resolution should be reduced for all the color planes can be made in step 325. In some embodiments, reduction of resolution in all color blocks of the current print frame may be desired so that the visual quality of the image may not be degraded. For example, if the print frame is in a region where there is a full color picture with a lot of details, resolution reduction in all color blocks may be desired. As another example, resolution reduction may be limited to tagged color blocks if the print frame is in a region where there is only white space (blank space) or solid colors.

If the resolutions of all the color blocks are to be reduced in the current print frame, the delta image blocks corresponding to all the compressed blocks may be removed in step 326. Otherwise, if only the resolutions of tagged color blocks are to be reduced, the delta image blocks corresponding to tagged color blocks may be removed in step 327.

After step 324, 326, or 327, it may be determined whether all the print frames have been formatted in step 328. If there is still at least one print frame of the image left unformatted, the algorithm may go back to step 321 and format the next print frame. The algorithm can iterate through steps 321-328 until all the print frames have been formatted. In step 329, image data of the processed print pages may be transferred from computer 200 to printer 100 with respective time durations D1 and D2 associated with each print page, after which exemplary process 30 may terminate.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for transferring image data to a printing device over a network connection, wherein the image data comprises at least one image block associated with a first print page, the image block comprising a plurality of color blocks, each color block being associated with a distinct color plane, the method comprising:
computing a transition delay for the transfer of a second print page immediately succeeding the first page, wherein the transition delay is computed based on a function of a physical offset between successive color planes in relation to an order in which the color planes are processed on the printing device and the volume of data in the image block; and
delaying scheduled transfers of image data associated with the second print page by the computed transition delay.

2. The method of claim 1, wherein computing the transition delay comprises:
receiving a specification of at least one area in the two print pages;
determining a first time duration to delay transfer of the second page, wherein the first time duration corresponds to the difference between the time of scheduled transfer of the second page and a computed time corresponding to the time of completion of transfers of all color blocks associated with the specified area of the first page;
determining a second time duration to delay transfer of the second page, wherein the second time duration corresponds to the difference between the time of scheduled transfer of color blocks associated with the specified areas of the second page and a computed time corresponding to the time of completion of transfers of all color blocks of the first page; and
setting the transition delay as the greater of the first time duration and the second time duration.

3. The method of claim 1, wherein computing the transition delay comprises:
determining a first time duration to delay transfer of the second page, wherein the first time duration corresponds to difference between the time of scheduled transfer of the second page and a computed time corresponding to the time of completion of transfers of all color blocks associated with at least one specified color plane of the first page;
determining a second time duration to delay transfer of the second page, wherein the second time duration corresponds to difference between the time of scheduled transfer of color blocks associated with at least one specified color plane of the second page and a computed time corresponding to the time of completion of transfers of all color blocks of the first page; and
setting the transition delay as the greater of the first time duration and the second time duration.

4. The method of claim 1, wherein computing the transition delay comprises computing a maximum transition delay that permits the image data of the first page to be transferred over the network connection within a time duration.

5. The method of claim 4, wherein the time duration is determined based on the available bandwidth of the network connection and a print speed of the printing device.

6. The method of claim 4, wherein the maximum transition delay is selected as the lower of computed maximum transition delay and a user-specified transition delay.

7. The method of claim 1, further comprising:
constructing a transfer frame using at least one color block based on the computed transition delay;
tagging at least one color block in the transfer frame, if the size of the transfer frame exceeds a threshold; and
reducing the resolution of the at least one color block that is tagged.

8. The method of claim 7, wherein the threshold is determined based on the available bandwidth of the network connection and a print speed of the printing device.

9. The method of claim 7, wherein reducing the resolution of the color block comprises:
deriving a lower resolution image and a delta image for the color block; and
removing the delta image.

10. The method of claim 1, further comprising:
constructing a transfer frame using at least one color block based on the computed transition delay;
tagging at least one color block in the transfer frame, if the size of the color block exceeds a threshold; and
reducing the resolution of the at least one tagged color block.

11. A computer-readable medium that contains instructions which, when executed by a processor, performs steps in a method for transferring image data to a printing device over a network connection, wherein the image data comprises at least one image block associated with a first print page, the image block comprising a plurality of color blocks, each color block being associated with a distinct color plane, the method comprising:
computing a transition delay for the transfer of a second print page immediately succeeding the first page, wherein the transition delay is computed based on a function of a physical offset between successive color planes in relation to an order in which the color planes are processed on the printing device and the volume of data in the image block; and
delaying scheduled transfers of image data associated with the second print page by the computed transition delay.

12. The computer-readable medium of claim 11, wherein computing the transition delay comprises:
receiving a specification of at least one area in the two print pages;
determining a first time duration to delay transfer of the second page, wherein the first time duration corresponds to the difference between the time of scheduled transfer of the second page and a computed time corresponding to the time of completion of transfers of all color blocks associated with the specified area of the first page;
determining a second time duration to delay transfer of the second page, wherein the second time duration corresponds to the difference between the time of scheduled transfer of color blocks associated with the specified areas of the second page and a computed time corresponding to the time of completion of transfers of all color blocks of the first page; and
setting the transition delay as the greater of the first time duration and the second time duration.

13. The computer-readable medium of claim 11, wherein computing the transition delay comprises:
determining a first time duration to delay transfer of the second page, wherein the first time duration corresponds to difference between the time of scheduled transfer of the second page and a computed time corresponding to the time of completion of transfers of all color blocks associated with at least one specified color plane of the first page;
determining a second time duration to delay transfer of the second page, wherein the second time duration corresponds to difference between the time of scheduled transfer of color blocks associated with at least one specified color plane of the second page and a computed time corresponding to the time of completion of transfers of all color blocks of the first page; and
setting the transition delay as the greater of the first time duration and the second time duration.

14. The computer-readable medium of claim 11, wherein computing the transition delay comprises computing a maximum transition delay that permits the image data of the first page to be transferred over the network connection within a time duration.

15. The computer-readable medium of claim 11, wherein the time duration is determined based on the available bandwidth of the network connection and a print speed of the printing device.

16. The computer-readable medium of claim 14, wherein the maximum transition delay is selected as the lower of computed maximum transition delay and a user-specified transition delay.

17. The computer-readable medium of claim 14, further comprising:
constructing a transfer frame using at least one color block based on the computed transition delay;
tagging at least one color block in the transfer frame, if the size of the transfer frame exceeds a threshold; and
reducing the resolution of the at least one color block that is tagged.

18. The computer-readable medium of claim 17, wherein the threshold is determined based on the available bandwidth of the network connection and a print speed of the printing device.

19. A system for transferring image data to a printing device over a network connection, wherein the image data comprises at least one image block associated with a first print page, the image block comprising a plurality of color blocks, each color block being associated with a distinct color plane, the system comprising:
a bandwidth limit inspector configured to compute a transition delay for the transfer of a second print page immediately succeeding the first page, wherein the transition delay is computed based on a function of a physical offset between successive color planes in relation to an order in which the color planes are processed on the printing device and the volume of data in the image block; and
a formatter configured to delay scheduled transfers of image data associated with the second print page by the computed transition delay.

20. The system of claim 19, wherein the bandwidth limit inspector is further configured to:
construct a transfer frame using at least one color block based on the computed transition delay; and
tag at least one color block in the transfer frame, if the size of the transfer frame exceeds a threshold,
wherein the formatter is further configured to reduce the resolution of the at least one color block that is tagged.
